(19) United States
(12) Patent Application Publication
(10) Pub. No.: US 2005/0021489 A1
(43) Pub. Date: Jan. 27, 2005

(54) Data mining structure

(75) Inventors: C. James MacLennan, Redmond, WA (US); Zhaohui Tang, Bellevue, WA (US); Pyungchul Kim, Sammamish, WA (US); Raman Iyer, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/624,278

(22) Filed: Jul. 22, 2003

(51) Int. Cl. G06F 7/00

(52) U.S. Cl. 707/1

(57) ABSTRACT

A mining structure is created which contains processed data from a data set. This data may be used to train one or more models. In addition to the selection of data to be used by model from data set, processing parameters are set, in one embodiment. For example, the discretization of a continuous variable into buckets, the number of buckets, and/or the sub-range corresponding to each bucket is set when the mining structure is created. The mining structure is processed, which causes the processing and storage of data from data set in the mining structure. After processing, the mining structure can be used by one or more models.

### FIELD OF THE INVENTION

This invention relates in general to the field of data mining. More particularly, this invention relates to the creation of multiple mining models based on the same data set.

### BACKGROUND OF THE INVENTION

Data Mining

Data mining is uncovering trends, patterns, and relationships from accumulated electronic traces of data. Data mining (sometimes termed “knowledge discovery”) allows the use of an enterprise data store by examining the data for patterns, e.g., to suggest better ways to produce profit, savings, higher quality products, and greater customer satisfaction. Data mining is used to sift through large amounts of data and the associated many competing and potentially useful dimensions of analysis and associated combinations.

For example, a business may amass a large collection of information about its customers. This information may include purchasing information and any other information available to the business about the customer. The predictions of a model associated with customer data may be used, for example, to control customer attrition, to perform credit-risk management, to detect fraud, or to make decisions on marketing.

Intelligent cross-selling support may be provided. For example, the data mining functionality may be used to suggest items that a user might be interested in by correlating properties about the user, or items the user has ordered, with a database of items that other users have ordered previously. Users may be segmented based on their behavior or profile. Data mining allows the analysis of segment models to discover the characteristics that partition users into population segments. Additionally, missing values in user profile data may be predicted. For example, where a user did not supply data, the value for that data may be predicted.

Data Mining Techniques

Many different techniques can be used in order to perform the analysis on the data. The most common data-mining techniques are decision trees, neural networks, cluster analysis, and regression.

Outcome modeling uses a set of input variables to predict or classify the value of a target, or response, variable (the outcome). The target variable can be categorical (having discrete values such as reply/did not reply) or continuous (having values such as dollar amount purchased). When the target is categorical, this is a classification task. When the target variable is continuous, the model is a regression model. Regression is the most common type of analysis that attempts to predict values of a continuous target variable based on the combined values of the input variables.

Decision trees are a common and robust technique for carrying out predictive modeling tasks that have an outcome field to train on. Decision trees are easy to work with, produce a highly readable graphic display, and work well with both categorical and continuous data. A decision tree works by collecting the overall data set (which is usually presented as the origin or root node of a decision tree at the top of the figure), and finding ways of partitioning the records or cases that occur in the root node to form branches. The branches are in the form of an upside-down tree, and the nodes at the ends of the branches are usually called leaves.

Segmentation is the process of grouping or clustering cases based on their shared similarities to a set of attributes. Decision trees also find segments but determine the segments based on a particular outcome variable. If no outcome variable exists or if it is desirable to view how observations group together in terms of their shared values in multiple outcome variables, then cluster analysis is used.

Cluster analysis forms groups of cases that are as homogeneous as possible on several shared attributes—such as height, weight, and age—yet are as different as possible when compared with any other clusters that are themselves homogeneous. In terms of personalized interaction, different clusters can provide strong cues to suggest different treatments.

Creation and Testing of Data Mining Models

For some data mining implementations, to create and test a data mining model, available data is divided into two parts. One part, the training data set, is used to create models. The rest of the data, the testing data set, is used to test the model, and thereby determine the accuracy of the model in making predictions. Once a data mining model has been created, it may be used to make predictions regarding data in other data sets.

Data within data sets is grouped into cases. For example, with customer data, each case may correspond to a different customer. Data in a case describes or is otherwise associated with one customer. One type of data that may be associated with a case (for example, with a given customer) is a categorical variable. As described above, a categorical variable categorizes the case into one of several pre-defined states. For example, one such variable may correspond to the educational level of a customer. In one example, there are various possible values for this variable. The possible values are known as states. For instance, the states of a marital status variable may be “married” or “unmarried” and may correspond to the marital state for the customer.

Another kind of variable which may be included in a case is a continuous variable. A continuous variable is one with a range of possible values. For example, one such variable may correspond to the age of a customer. Associated with the age variable is a range of possible values for the variable.

In order to train a model, initial data processing must occur on the training set. In one mining system, the first step is to read the raw data from a relational or multidimensional data source and translate it to a form that is understandable by the training code—the training format. This training format representation may be in the form of attribute numbers and corresponding state values, for example. If a variable is “Gender” and the possible values for it are “Male” and “Female” the corresponding attribute number for the variable may be 1 and the corresponding state value for “Male” may be 1 and for “Female” may be 2. In this case, in the training format the a specific case may include a pair (1,1) indicating that the variable Gender has a value of Male for that state. Additionally, initial data processing may include a variety of other tasks, including tokenization and/or the discretization of a continuous variable by breaking the possible range of the variable into sub-ranges. In this way, values for a continuous variable can be used to train a model.

As mentioned, available data is partitioned into two groups—a training data set and a testing data set. Often 70% of the data is used for training and 30% for testing. A model may be trained on the training data set, which includes this information. Once a model is trained, it may be run on the testing data set for evaluation. For example, during this testing, the model can be given all of the data except the age data, and asked to predict the customer's age given the other data. Running the model on the testing data set, the results produced by the model are compared to the actual testing data to see how successful the model was at correctly predicting the age of the customer. After such training and evaluation, a successful model may be used on other data sets.

Two or more models may be trained on the same data set. When this occurs, the initial data processing is performed once for each model. Additionally, if a model is being trained from a data set, the initial data processing must be performed again. This must occur for each model where a change has been made.

Thus, there is a need for a way to eliminate this duplication in reading the data from the data set and data processing and to provide other advantages which minimize processing time and complexity for users.

### SUMMARY OF THE INVENTION

Pre-processed data for the training of mining models is provided from data set training data comprising at least one set of case data, where each of the sets of case data comprises a stored value for at least one variable from among a set of at least one variable. A group of at least one mining structure variable is found from among the set of at least one variable. These mining structure variables are the variables which will be used for or included in the mining structure. For each mining structure variables from, the data set training data, the stored value is retrieved. Mining model initial processing is performed on these retrieved values, and the results are stored.

Mining models may then be trained using the mining structures. Data may be requested from the mining structure for training or drill through purposes. When more than one mining model has been trained on one mining structure, the initial processing need not be performed multiple times.

Thus, the mining structure describes how the source data will be modeled for data mining. The mining structure can be shared by multiple models that are built on the same data set. Additionally, the mining structure is a container for the mapping of source data to the format. The data contained in the mining structure can then be used by the training code for all models which are based on the structure.

Other embodiments are described below.

### BRIEF DESCRIPTION OF THE DRAWINGS

The foregoing summary, as well as the following detailed description of presently preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2 is a block diagram of the interrelationships between data sets, mining structures, and mining models;

FIG. 3 is a flow diagram of a method for providing pre-processed data for the training of a mining model according to one embodiment of the invention; and

FIG. 4 is block diagram illustrating the interrelationships including those between a mining model and a mining structure.

### DETAILED DESCRIPTION OF ILLUSTRATIVE EMBODIMENTS

Overview

In accordance with the invention, a mining structure is created which includes processed data from a data set. This data may be used to train one or more models. The mining structure is created when the data to be stored in the data set is set forth. The processing of the mining structure performs the pre-processing of the data for the mining structure which is stored in the mining structure.

Exemplary Computing Environment

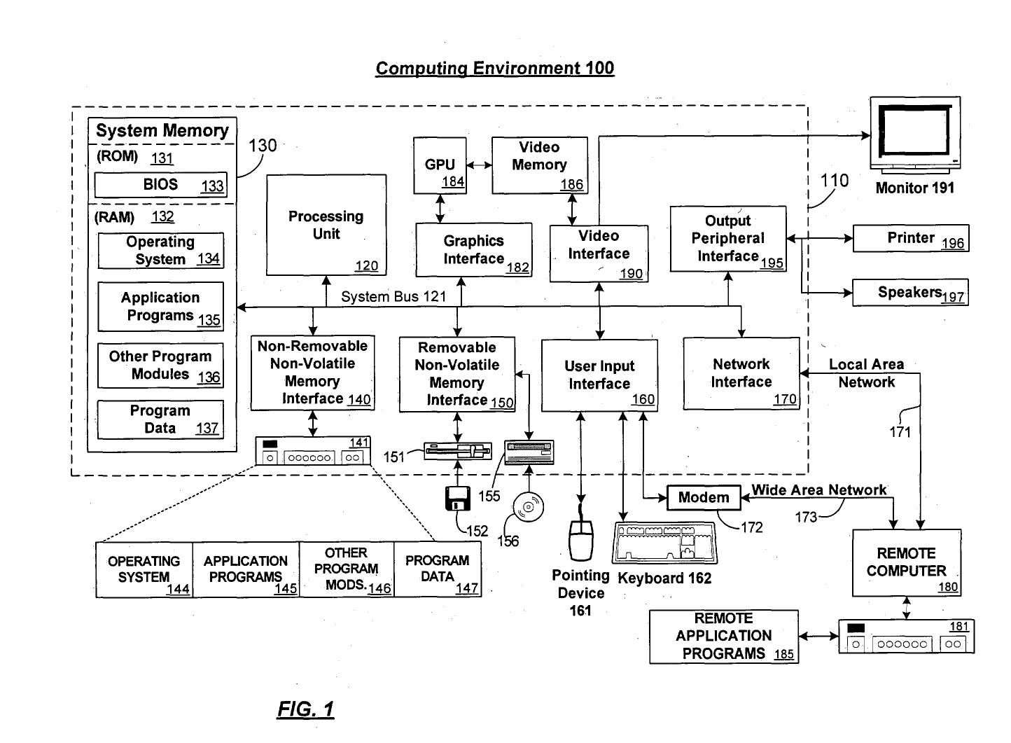

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices. Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the techniques of the present invention.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium that can be used to store the desired information and that can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide, computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

While some exemplary embodiments herein are described in connection with software residing on a computing device, one or more portions of the invention may also be implemented via an operating system, application programming interface (API) or a “middle man” object, a control object, hardware, firmware, etc., such that the methods may be included in, supported in or accessed via all of NET's languages and services, and in other distributed computing frameworks as well.

Processing of Data Set Cases Using a Mining Structure

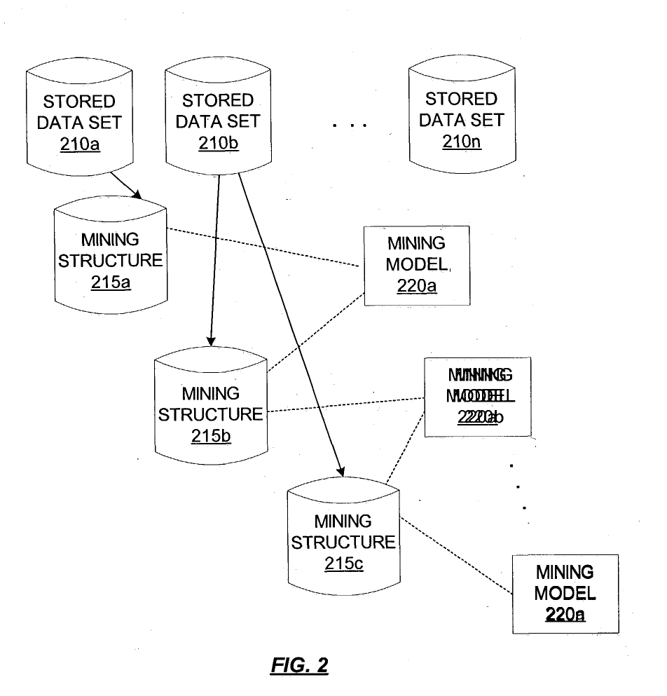

FIG. 2 is a block diagram showing relationships between data sets, mining models, and mining structures. As shown in FIG. 2, data sets 210a-210n are stored. Each case in each data set 210 includes stored values. For example, in a data set 210 describing customers, for each case a key value will be stored. In addition, a value may be stored for one or more variables. These variables, for example, may include variables describing income, marital status, age, gender, and education. The values for each variable in data set 210 are of various types. For example, the variable describing gender may be a discrete variable, with possible values selected from the set {male, female}. The variable describing income may be a continuous variable, meaning that the value of the variable for a specific case can take on any value within a range of possible values. While the variable may take any value in the range of possible variables, a limitation is imposed when the value for the variable is stored in data set 210. The value will be stored with a specific data type. For example, a continuous variable may be stored as an integer or long value.

A mining structure is a container for processed information from a data set 210. As shown in FIG. 2, mining structures 215a, 215b and 215c have been created. More than one mining structure 215 may be created from any data set 210. As shown in FIG. 2, mining structure 215a has been created for processed information from data set 210a. Mining structures 215a and 215b have been created for processed information from data set 210b. No mining structure 215 has been created for processed information from data set 210n.

As mentioned, a mining structure 215 is a container for processed information from a data set 210. In one embodiment, a mining structure is treated as a first-class object in a database. Any number of operations can operate on a mining structure 215; these include create, process, clear, and drop operations. These are described in greater detail below. The create operation sets up the mining structure 215, defining the data from data set 210 to be included and, in one embodiment, defining discretization parameters for discretizing a continuous variable. The process operation performs the initial processing on data set 210 data for mining model creation. Only the data necessary per the definitions in the mining structure is processed. Discretization is also performed as per the mining structure definition. The clear operation removes the content from a processed mining structure 215. The drop operation deletes a mining structure 215. Update and query operations may also be performed on a mining structure 215. The update operation causes the mining structure 215 to be reprocessed from the data set 210. The query operation returns the requested values from the mining structure 215. In one embodiment, the query operation will perform a translation from the data as stored in the mining structure 215 into a more user-comprehensible format. For example, the result of a query may be presented in the format of the original data set 210.

In order to train a mining model 220, initial processing of data set 210 must occur. For example, the continuous variable describing income will be discretized before it can be used in a mining model 220. This discretization transforms data from a continuous variable. The range of possible values for the variable is broken into sub-ranges, also called buckets. Instead of considering the value for the variable, the mining model 220 will consider which bucket the value falls into. Additionally, initial processing may include the creation of a new variable using one or more existing variables in the data set. For example, for such a new variable, for each case, the value for the new variable for the case is dependent on the value(s) of the one or more existing variables on which the new variable depends. The calculation of the value for the new variable is, in one embodiment, included in the initial processing.

Creating a Mining Structure

The create operation creates a mining structure 215. In order to create a mining structure 215, a determination is made regarding what data should be included in the mining structure 215. When creating a mining structure 215, in one embodiment, the user decides which variables in data set 210 should be used for the mining models 220 which will be trained based on that mining structure 215. In one embodiment, the user decides which continuous variables in data set 210 should be discretized. In still another embodiment, the user specifies the buckets into which a continuous variable should be discretized.

For example, in one embodiment a mining structure 215 is created with the following statement:

```
Create mining structure Customer_Structure (
  Customer_id long key,
  Income long continuous,
  Marital_status text discrete,
  Age int descretized(),
  Education text discrete not_null,
  Member_card text discrete
)
```

The creation statement indicates which variables are to be included in the mining structure 215, and whether any of them are to be discretized. In the exemplary creation statement, a mining structure called “Customer_Structure” is created. This mining structure includes a key value, “Customer_id,” which is used to uniquely identify each of the cases. Customer_id is of type long. Additionally, Customer_Structure will include a variable “Income,” which is a continuous variable of type long. “Marital_status,” “Education,” and “Member_card” are three discrete variables of type text which are also included in the customer structure. Age is a continuous variable which will be discretized in the mining structure.

Processing, Clearing and Dropping a Mining Structure

When a mining structure 215 is processed, data from data set 210 is processed and stored in a mining structure 215 which had been described with a creation statement. For each non-discretized case, for each variable in the mining structure 215, the value of that variable for that case (if a value is present) is stored in the mining structure 215.

When a clear operation is performed on a mining structure 215, the data contained in the mining structure 215 is removed. A drop operation deletes the mining structure 215, and any data contained in it.

Using a Mining Structure

In order to train a mining model 220 from a mining structure, rather than directly from a data structure, in one embodiment, a mining model creation function is created which allows model creation directly from the mining structure. Where the mining model creation previously was performed using data set 210, a mining model creation function according to the invention uses the mining structure 215.

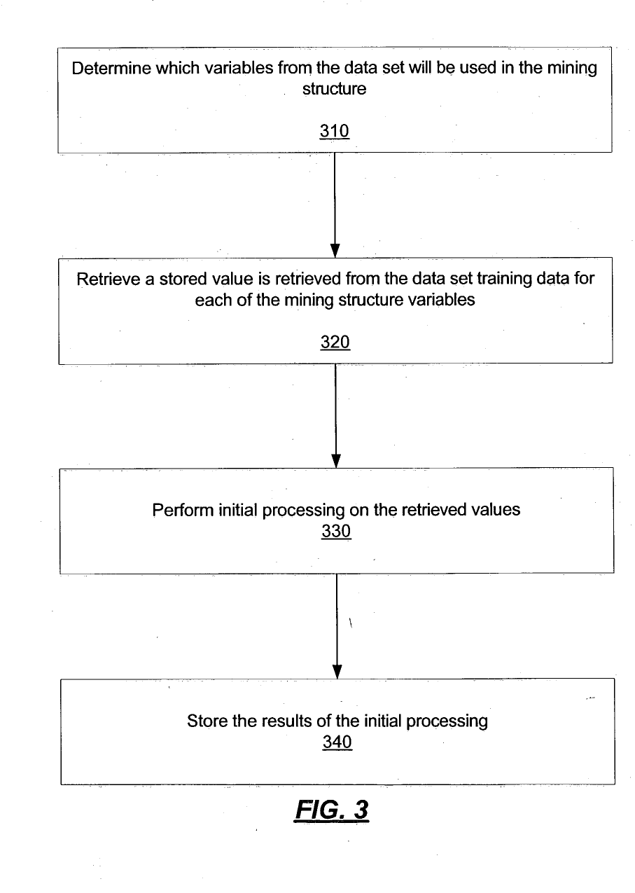

FIG. 3 is a flow diagram of a method for providing pre-processed data for the training of a mining model from data set training data according to one embodiment of the present invention. In FIG. 3, for a first step 310, a determination is made of which variables from the data set will be used in the mining structure. These will be the mining structure variables. In step 320, a stored value is retrieved from the data set training data for each the mining structure variables. In step 330, initial processing is performed on the retrieved values, and in step 340, the results of this initial processing are stored.

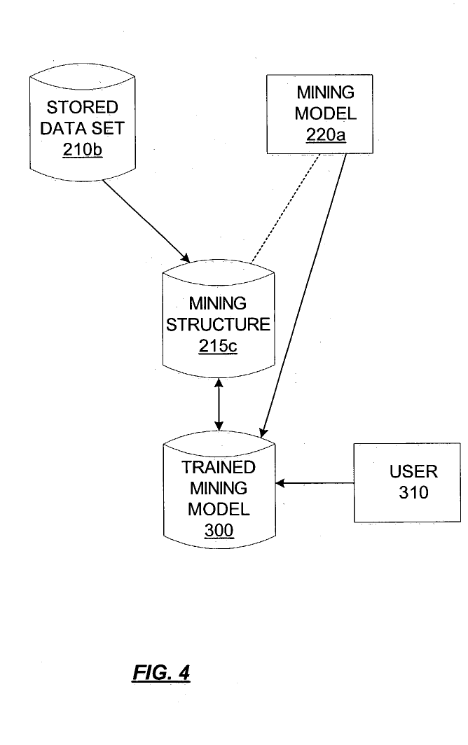

FIG. 4 is a block diagram illustrating interrelationships between the containers and concepts being described. A stored data set 210b is used to populate a mining structure 215c. A mining model 220a is associated with the mining structure 215c. When a copy of the mining model 220a is trained on the mining structure 215c, trained mining model 300 results. A user 310 uses tools to view and use the trained mining model 300. Drill through from the trained mining model to the data in the mining structure, in one implementation, is also enabled.

In one embodiment, mining model creation may be done either from a mining structure 215 or from a data set 210. In one embodiment, the mining model creation function detects whether a mining structure 215 has been created; if a mining structure 215 has been created, the model is created from the mining structure 215, but if no mining structure 215 has been created, a mining structure 215 is created and processed, and then a model is created from that mining structure 215.

Two or more different mining structures 215 may be created from the same data set 210. As shown in FIG. 2, both mining structure 215b and 215c are created from the same data set 210b. This may occur because different data is included in the different mining structures 215b and 215c or because different processing of the data occurs. For example, one mining structure 215 may discretize a continuous variable into five possible sub-ranges, while a second mining structure 215 may discretize the variable into five different possible sub-ranges.

These differences may result in different mining models 220 when mining models are trained from the different mining structures 215. As shown in FIG. 2, mining models 220 are trained from the mining structures. The relationships between mining models 220 and mining structures 215 are shown by dotted lines. Where a mining model 220 is shown connected to multiple mining structures 215, two copies of the mining model exist, one trained on each of the mining structures.

For example, one copy of mining model 220a is trained on mining structure 215a, a second copy is trained on mining structure 215b. One copy of mining model 220a is trained on mining structure 215b, a second copy is trained on mining structure 215c. In this way, four models are calculated. The results and accuracy of the models may be compared. Because mining structures 215 and 215c are both created from data set 210b, the results of training mining model 220b on the two different mining structures can be compared by comparing the two different resulting mining models 220. Additionally, because a copy of mining model 220a is trained on mining structure 215b, and a copy of mining model 220b is trained on mining structure 215b as well, a comparison of the two mining models on the data set 210b (as processed and contained in mining structure 215b) may be performed.

Thus, a performance comparison of mining models derived from a first mining structure and mining models derived from a second mining structure may be performed. When mining model results are displayed, e.g. in a decision tree or a cluster graph, a drill-through operation may be supported. In response to such an operation, data from the mining structure 215 which was used to train the model is presented, because it is the data underlying the mining model. If the mining structure 215 has been cleared or dropped, a drill-through will be unsuccessful.

In one embodiment, the link between one or more mining models 220 and a mining structure 215 is stored. If the mining structure 215 is changed and reprocessed, the mining models 220 will be reprocessed. Thus, the effect of a change in the processing of data set 210, for example, by changing the number and/or ranges of buckets into which a continuous variable is discretized, is reflected in a number of mining models 220 simultaneously when the mining structure and mining models are reprocessed, saving user time, processing time (since the initial processing of a data set 210 is not reduplicated for each mining model) and eliminating possible inconsistencies in the way a data set 210 is used, making comparisons between mining models more assuredly accurate.

While the present invention has been described with reference to relational data sources, the applicability of the invention described is not limited to such data sources. For example, and without limitation, it is contemplated that the present invention can be practiced in a context where the data source is multidimensional, such as a on-line analytical processing (OLAP) cube source, or of any other mining model data type.

There are multiple ways of implementing the present invention, e.g., an appropriate API, tool kit, driver code, operating system, control, standalone-or downloadable software object, etc. which enables applications and services to use the product configuration methods of the invention. The invention contemplates the use of the invention from the standpoint of an API (or other software object), as well as from a software or hardware object that communicates in connection with product configuration data. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to implement product configuration. Thus, the techniques for encoding/decoding data in accordance with the present invention may be applied to a variety of applications and devices. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. With respect to embodiments referring to the use of a control for achieving the invention, the invention is not limited to the provision of a .NET control, but rather should be thought of in the broader context of any piece of software (and/ore hardware) that achieves the configuration objectives in accordance with the invention. One of ordinary skill in the art will appreciate that there are numerous ways of providing object code and nomenclature that achieves the same, similar or equivalent functionality achieved by the various embodiments of the invention. The term “product” as utilized herein refers to products and/or services, and/or anything else that can be offered for sale via an Internet catalog. The invention may be implemented in connection with an on-line auction or bidding site as well.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the product configuration techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

1. A method for providing pre-processed data for the training of mining models from data set training data comprising at least one set of case data, each of said sets of case data comprising a stored value for at least one variable from among a set of at least one variable, comprising:
determining at least one mining structure variable from among said set of at least one variable;
for each case, retrieving a stored value for each of said at least one mining structure variables from said data set training data;
performing mining model initial processing on said retrieved values; and
storing the results of said mining model initial processing.

2. The method of claim 1, where said step of determining at least one mining structure variable from among said set of at least one variable comprises:
accepting creation operation data comprising data comprising the identity of said mining structure variables.

3. The method of claim 2, where said at least one mining structure variable comprises a continuous variable, where said creation operation data comprises an indication regarding discretization of said continuous variable, and where said step of performing mining model initial processing on said retrieved values comprises discretizing said continuous variable according to said indication.

4. The method of claim 3, where said indication comprises an indication of a number of buckets into which said continuous variable should be discretized.

5. The method of claim 3, where said indication comprises an indication of sub-ranges into which said continuous variable should be discretized.

6. The method of claim 1, where said stored results are associated with at least one mining model, and where each of said at least one mining model is trained using said stored results.

7. A computer readable medium comprising computer executable modules having computer executable instructions, said modules providing pre-processed data for the training of mining models from data set training data comprising at least one set of case data, each of said sets of case data comprising a stored value for at least one variable from among a set of at least one variable, said computer executable modules comprising:
a mining structure variable determination module for determining at least one mining structure variable from among said set of at least one variable;
a data set training data retrieval module for each case, retrieving a stored value for each of said at least one mining structure variables from said data set training data;
an initial processing module for performing mining model initial processing on said retrieved values; and
a storage module for storing the results of said mining model initial processing.

8. The computer readable medium of claim 7, where said mining structure variable determination module accepts creation operation data comprising data comprising the identity of said mining structure variables.

9. The computer readable medium of claim 8, where said at least one mining structure variable comprises a continuous variable, where said creation operation data comprises an indication regarding discretization of said continuous variable, and where said initial processing module discretizes said continuous variable according to said indication.

10. The computer readable medium of claim 9, where said indication comprises an indication of a number of buckets into which said continuous variable should be discretized.

11. The computer readable medium of claim 9, where said indication comprises an indication of sub-ranges into which said continuous variable should be discretized.

12. The computer readable medium of claim 9, where said stored results are associated with at least one mining model, and where each of said at least one mining model is trained using said stored results.

13. An application programming interface for use in connection with providing pre-processed data for the training of mining models from data set training data comprising at least one set of case data, each of said sets of case data comprising a stored value for at least one variable from among a set of at least one variable, wherein said application programming interface receives as input creation operation data comprising data comprising the identity of mining structure variables from among said set of at least one variable; for each case, retrieves a stored value for each of said at least one mining structure variables from said data set training data; performs mining model initial processing on said retrieved values; and stores the results of said mining model initial processing.

14. The application programming interface of claim 13, where said at least one mining structure variable comprises a continuous variable, where said creation operation data comprises an indication regarding discretization of said continuous variable, and where said application programming interface discretizes said continuous variable according to said indication.

15. The application programming interface of claim 14, where said indication comprises an indication of a number of buckets into which said continuous variable should be discretized.

16. The application programming interfaceof claim 14, where said indication comprises an indication of sub-ranges into which said continuous variable should be discretized.

17. The application programming interface of claim 13, wherein said query is sent and said stored results are retrieved via at least one network.

18. The application programming interface of claim 13, where said stored results are associated with at least one mining model, and where each of said at least one mining model is trained using said stored results.

19. A system for providing pre-processed data for the training of mining models from data set training data comprising at least one set of case data, each of said sets of case data comprising a stored value for at least one variable from among a set of at least one variable, said system comprising:
an application programming interface, said application programming interface (a) receiving as input creation operation data comprising data comprising the identity of mining structure variables from among said set of at least one variable; (b) for each case, retrieving a stored value for each of said at least one mining structure variables from said data set training data; (c) performs mining model initial processing on said retrieved values; and (d) stores the results of said mining model initial processing; and
a database for storing said data set, operably connected with said application programming interface, and for returning said stored values to said application programming interface.

20. A system for providing pre-processed data for the training of mining models from data set training data comprising at least one set of case data, each of said sets of case data comprising a stored value for at least one variable from among a set of at least one variable, said system comprising:
determination means for determining at least one mining structure variable from among said set of at least one variable;
retrieval means for each case, retrieving a stored value for each of said at least one mining structure variables from said data set training data;
initial processing means for performing mining model initial processing on said retrieved values; and
storage means for storing the results of said mining model initial processing.

21. The system of claim 20, where said determination means comprises:
data acceptance means for accepting creation operation data comprising data comprising the identity of said mining structure variables.

22. The system of claim 21, where said at least one mining structure variable comprises a continuous variable, where said creation operation data comprises an indication regarding discretization of said continuous variable, and where initial processing means comprises discretization means for discretizing said continuous variable according to said indication.

23. The system of claim 22, where said indication comprises an indication of a number of buckets into which said continuous variable should be discretized.

24. The system of claim 22, where said indication comprises an indication of sub-ranges into which said continuous variable should be discretized.

25. The application programming interface of claim 22, where said stored results are associated with at least one mining model, and where each of said at least one mining model is trained using said stored results.

26. A method for the training of a mining model from data set training data comprising at least one set of case data, each of said sets of case data comprising a stored value for at least one variable from among a set of at least one variable, comprising:
determining at least one mining structure variable from among said set of at least one variable;
for each case, retrieving a stored value for each of said at least one mining structure variables from said data set training data;
performing mining model initial processing on said retrieved values;
storing the results of said mining model initial processing in a mining structure; and
training said mining model using said stored results.

27. The method of claim 26, further comprising:
storing connection data indicating that said mining model has been trained on data from said mining structure.

28. The method of claim 26, further comprising:
accepting a drill through query for specified data from said mining structure and providing said specified data.

29. The method of claim 26, where additional mining models are associated with said mining structure, and where said method further comprises:
training each of said additional mining models using said stored results.

30. The method of claim 26, where said mining structure is treated as a first class object in a database.

31. A computer readable medium comprising computer executable modules having computer executable instructions, said modules training a mining model from data set training data comprising at least one set of case data, each of said sets of case data comprising a stored value for at least one variable from among a set of at least one variable, said modules comprising:
a mining structure variable determination module for determining at least one mining structure variable from among said set of at least one variable;
a data set training data retrieval module for each case, retrieving a stored value for each of said at least one mining structure variables from said data set training data;
an initial processing module for performing mining model initial processing on said retrieved values;
a storage module for storing the results of said mining model initial processing; and
a training module for training a mining model using said stored results.

32. The computer readable medium of claim 31, said modules further comprising:
connection data storage module storing connection data indicating that said mining model has been trained on data from said mining structure.

33. The computer readable medium of claim 31, said modules further comprising:
drill through module for accepting a drill through query for specified data from said mining structure and providing said specified data.

34. The computer readable medium of claim 31, where additional mining models are associated with said mining structure, and where said training module further trains each of said additional mining models using said stored results.

35. The computer readable medium of claim 31, where said mining structure is treated as a first class object in a database.
